(19) United States
(12) Patent Application Publication
(10) Pub. No.: US 2007/0039130 A1
(43) Pub. Date: Feb. 22, 2007

(54) Door closer

(76) Inventor: Jang-Woo Song, Yongin-Si (KR)

Correspondence Address: IPLA P.A., 3580 WILSHIRE BLVD., 17TH FLOOR, LOS ANGELES, CA, 90010, US

(21) Appl. No.: 10/595,673

(22) PCT Filed: Nov. 9, 2004
(86) PCT No.: PCT/KR04/02885

§ 371 Date: May 3, 2006

(30) Foreign Application Priority Data
Nov. 12, 2003 (KR) 20-2003-0035431
Apr. 8, 2004 (KR) 20-2004-0009740

(51) Int. Cl. E05F 3/10

(52) U.S. Cl. 16/52

(57) ABSTRACT

The apparatus for closing the door slowly and automatically can directly get the door closed by the piston rod without passing through a gear, so that the energy loss is little, and a small amount of air is contained in the hydraulic oil in order for the piston and the piston rod to be moved to the left and right hand side. The closing speed of the door can be adjustable by turning a speed adjustment bolt and for the installation, it is very easy to install the present invention since the function of the invention works with a force adjustment by turning the force adjustment nut when the invention is fixed to the door and doorframe.

### TECHNICAL FIELD

The present invention relates to a door closer for closing automatically slowly various kinds of opening and closing doors.

### BACKGROUND ART

Conventionally, in order for the door to be closed automatically, as shown in FIG. 2, a spring and a gear are installed inside the cylindrical-shaped body, which is filled with hydraulic oil. The restoring force of the spring transferred to the gear a 72, the gear b 73, and the link 74 allows the door to be closed slowly. In the conventional product, the restoring force of the spring is transferred through a gear and a link in order for the door to be closed so that a power loss is incurred and a very strong compression spring is required, and the structure is complicated and heavy because of the built-in gear, and the outer appearance may be spoiled due to the link attached outside. In addition, in order to adjust the opening and closing force of the door after installation, as in FIGS. 2 and 3, the link 74 is disassembled from the catch rod 73a formed on the gear b 73, and the assembling angle of the link 74 to the catch rod 73a is changed to compress the spring 71, and the link is reinstalled for a force adjustment, so that it is very inconvenient to adjust the force, and a higher power is needed for the force adjustment. It must be installed by the specialist for the adjustment of the mounting position to the door and the doorframe and the length of the link. However, according to the present invention, the restoring force of the spring is directly transferred to the piston rod for closing the door without necessity of the gear. A small amount of air is contained in hydraulic oil to enable the piston rod to move forward and backward. A speed adjustment bolt is mounted to the edge of both sides of the cylinder for the door to be closed quickly or slowly. Also, a force adjustment nut, which is essentially required for installation of the present invention to the door and the doorframe, is assembled to one end of the piston rod to adjust opening and closing force when the door is opened and closed.

### DISCLOSURE OF INVENTION

The present invention has been made in order to solve the above problems occurring in the art, and it is an object of the invention to provide a door closer. In the conventional product, the restoring force of the spring is transferred to a gear and a link to close the door, so that it generates much power loss and a very strong compression spring is required, and the structure is complicated and heavy because of the built-in gear, and the appearance is spoiled due to the link attached outside. In addition, installation is very hard so that a specialist should install it. It is not appropriate to install it to the wooden or lightweight door because of easy damage of mounting portion. It is very inconvenient because it must be disassembled for a force adjustment after installation. It should be reinstalled to the door after the force adjustment.

The present invention enables the restoring force of the spring to be directly transferred to the piston rod and to close the door skipping the gear, and a small amount of air is contained in hydraulic oil to enable the piston rod to move forward and backward. In addition, a speed adjustment bolt is mounted to the edge of both sides of the cylinder for adjusting the closing speed of the door. Also a force adjustment nut which is essentially required when the invention is installed to the door and doorframe is assembled to one end of the piston rod to adjust the closing force of the door.

In the present invention, the restoring force of the spring is directly transferred to the piston rod without through a gear to thereby allow the door to be closed so that a power loss is little, and it is light and a simple structure, thereby having a nice appearance. Also the closing speed of the door is adjusted simply by turning the speed adjustment bolt, and for the installation, it only requires turning the force adjustment nut after mounting the invention to the door and the doorframe, so that even a beginner can install it because installation is so easy. The adjustment of opening and closing force of the door is done by turning only the force adjustment nut so that it is easy to adjust the force. In addition, it can be applied to the weak or light door because the mounting portion of the door and the doorframe is not damaged due to the weak spring used.

### BRIEF DESCRIPTION OF DRAWINGS

Further objects and advantages of the invention can be more fully understood from the following detailed description taken in conjunction with the accompanying drawings, in which:

FIG. 1 is a perspective view of a conventional door closer;

FIG. 2 shows the inside structure of the conventional door closer;

FIG. 3 is an enlarged and exploded view of the portion A shown in FIG. 2;

FIG. 4 is a perspective view of a door closure according to the present invention;

FIG. 5 shows the internal structure of the door closer according to the present invention;

FIG. 6 shows a cross section taken along the line F-F in FIG. 5;

FIG. 7 is a cross sectional view taken along the line G-G in FIG. 6;

FIG. 8 is an enlarged perspective view of the portion marked by reference numeral 2a in FIG. 7;

FIG. 9 is an enlarged view of the portion B in FIG. 5;

FIG. 10 is an enlarged view of the portion C in FIG. 5;

FIG. 11 is an enlarged view of the portion D of FIG. 5;

FIG. 12 is an enlarged view of the portion E of FIG. 5;

FIG. 13 is a cross sectional view taken along the line H-H in FIG. 9;

FIG. 14 is a cross sectional view taken along the line H′-H′ in FIG. 10;

FIG. 15 is a detailed view of the portion marked by reference numeral 4 in FIG. 5;

FIG. 16 is an enlarged exploded view of the portions marked by reference numerals 8 and 8a in FIG. 5;

FIG. 17 is an enlarged view of the portion marked by reference numeral 6a in FIG. 5;

FIG. 18 is an enlarged view of the portion marked by reference numeral 6b in FIG. 5;

FIG. 19 shows an installation example of the door closer of the invention where the door closer is installed to a door (an elevational view);

FIG. 20 shows an installation example of the door closer of the invention (a top plan view);

FIG. 21 shows an installation example of the door closer of the invention where the door is opened (a top plan view 1);

FIG. 22 shows an installation example of the door closer of the invention where the door is opened (a top plan view 2);

FIG. 23 is a perspective view of the present invention for installation to the closing side of the door;

FIG. 24 shows the internal structure of the present invention for installation to the closing side of the door;

FIG. 25 is an installation example view of the present invention for installation to the closing side of the door (an elevational view);

FIG. 26 is an installation example view 1 of the present invention for installation to the closing side of the door (a top plan view); and

FIG. 27 is an installation example view 2 of the present invention for installation to the closing side of the door (a top plan view).

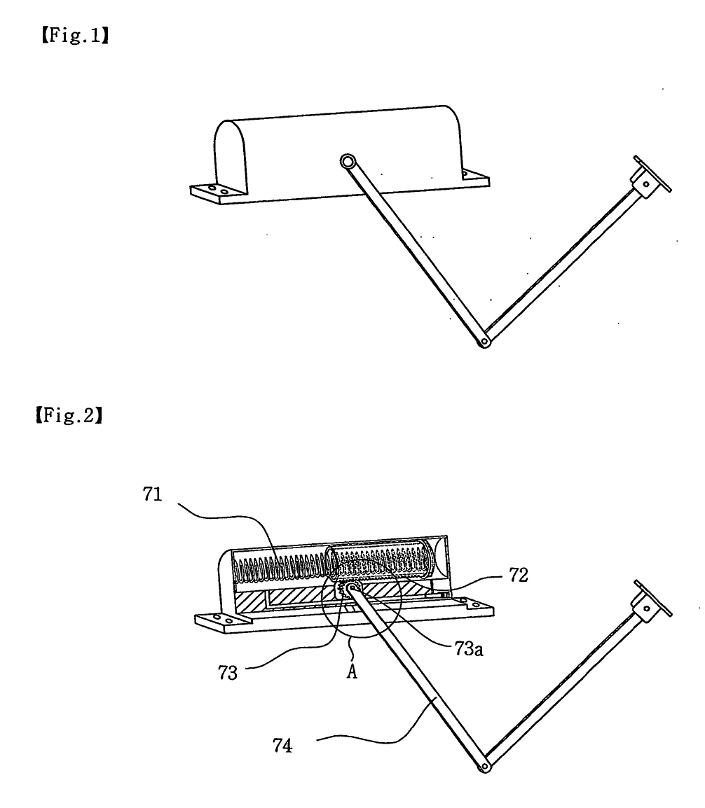

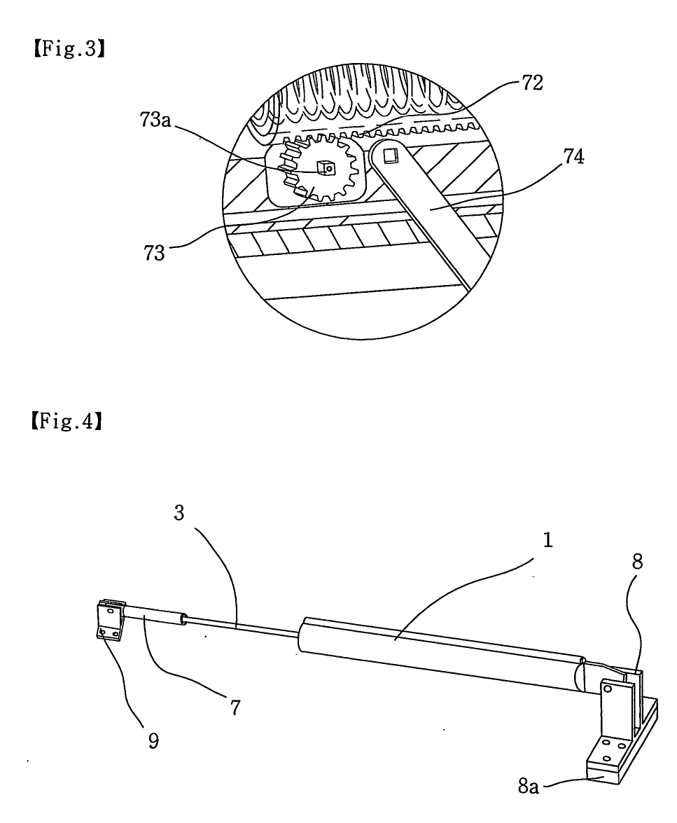

### BEST MODE FOR CARRYING OUT THE INVENTION

The preferred embodiments of the present invention will be hereafter described in detail with reference to the accompanying drawings.

A spring 5, a spring guide 4, a piston 2, and a piston rod 3 are mounted inside of a cylinder 1, which is filled with hydraulic oil containing a small amount of air. A speed adjustment bolt 6a, 6b is formed on the edge of both ends of the cylinder. A doorframe mounting device 8 is attached to one end of the cylinder, and a door mounting device 9 is attached to the other end of the cylinder via the piston rod 3. Also, a force adjustment nut 7 is mounted between the door mounting device 9 and the piston rod.

In the present invention, a doorframe mounting device 8 capable of mounting an additional supporter 8a is assembled if necessary to one end of a cylinder 1. Inside of the cylinder 1 is built in a piston 2 which forms a hole 2a having a catch rod 2a′ therein and a ball 2b disposed therein, a spring guide 4, and a spring 5. A piston rod 3 is attached to the piston 2, and a mail screw is formed at one side end portion of the piston rod 3. A force adjustment nut 7 having a female screw formed therein is assembled to the piston rod, and a door mounting device 9 is mounted to the force adjustment nut 7. Speed adjustment bolts 6a, 6b are attached to the edge of both sides end, and the cylinder chamber 1a, 1b is filled with hydraulic oil containing a little air. The reference numerals (not described) 20a, 20b, 20c, and 20d are oil seals, and 4a is a sliding bearing. The reference numerals 1c, 1d, 1e, and 1f are oil holes, and 30a, 30b, and 30c are rotation centers. The reference numeral 30 is a connection line of rotation center.

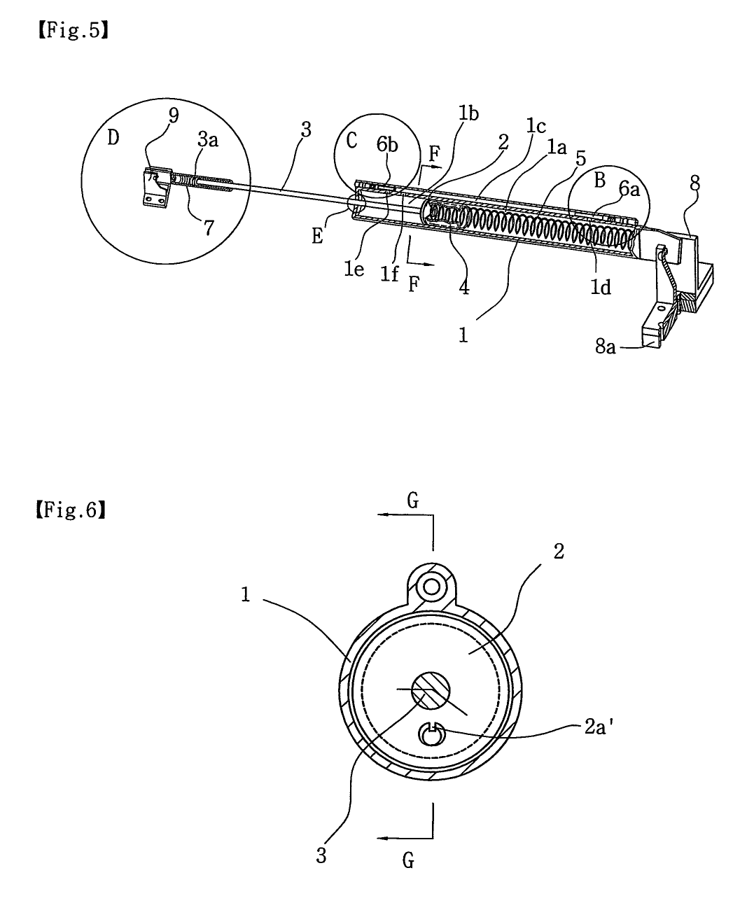

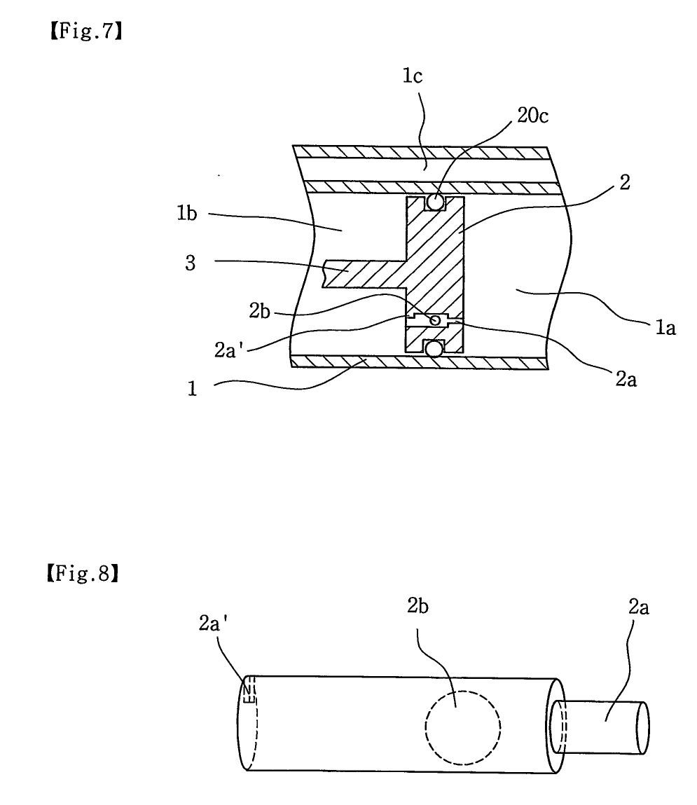

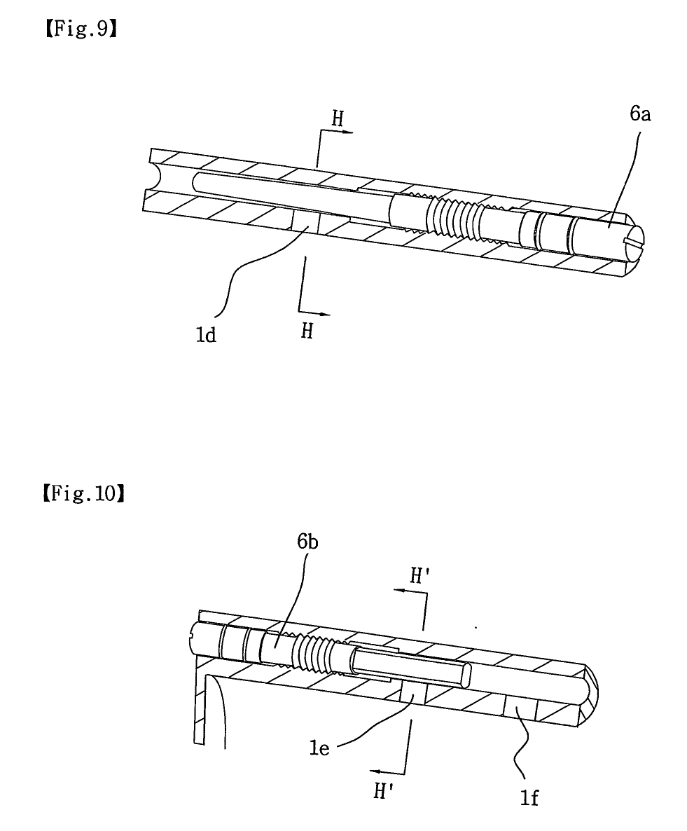

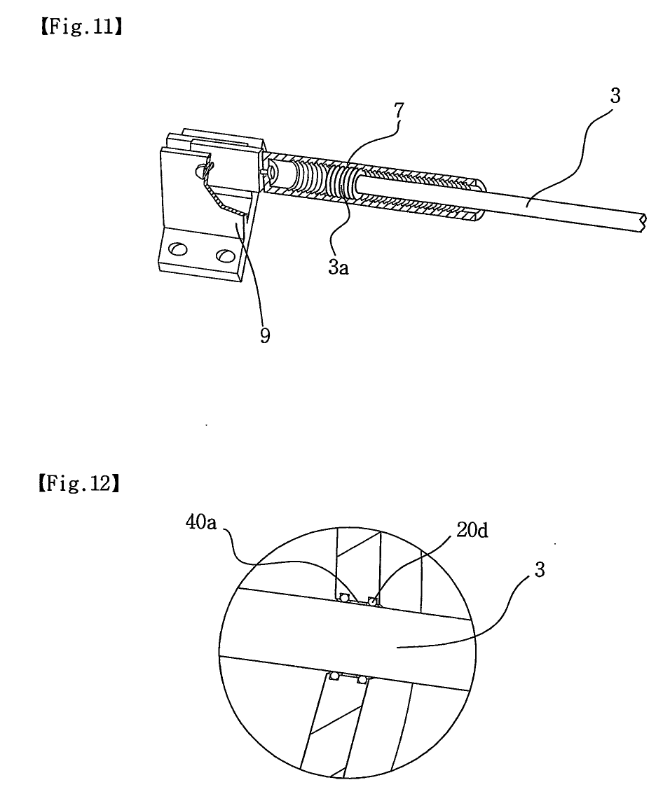

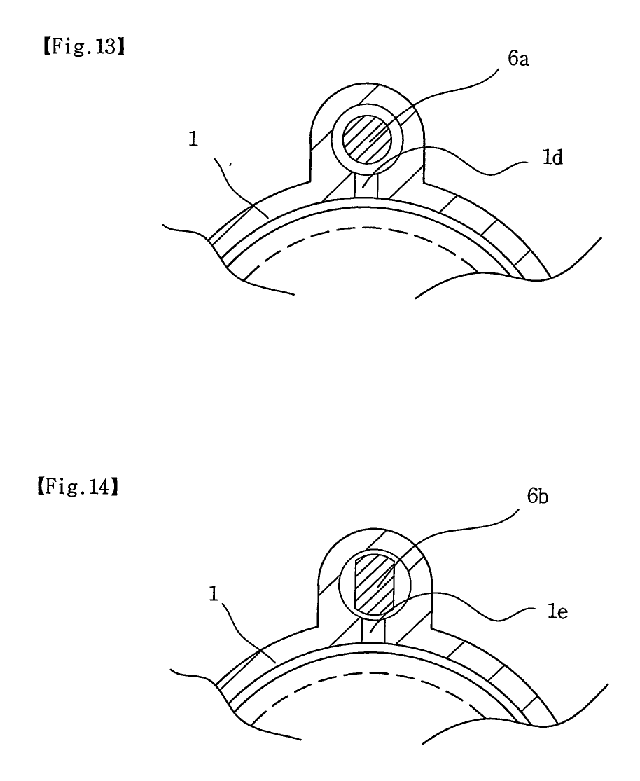

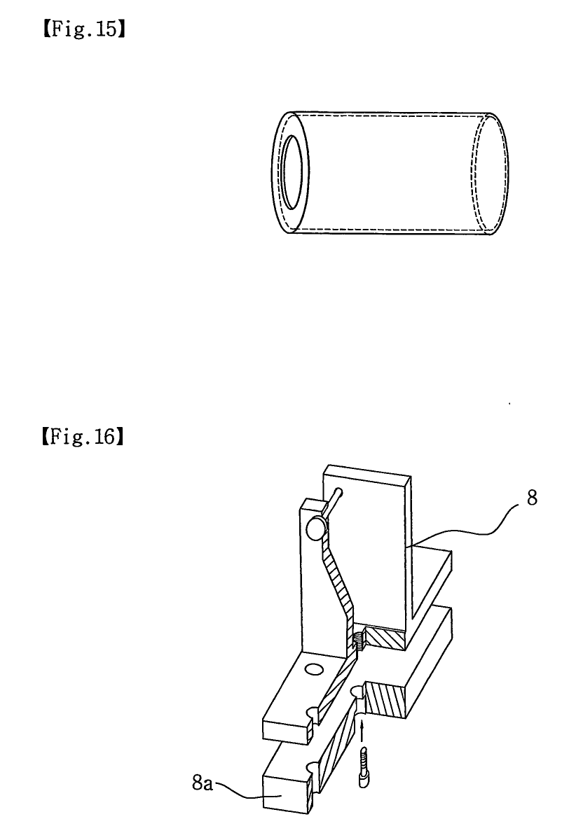

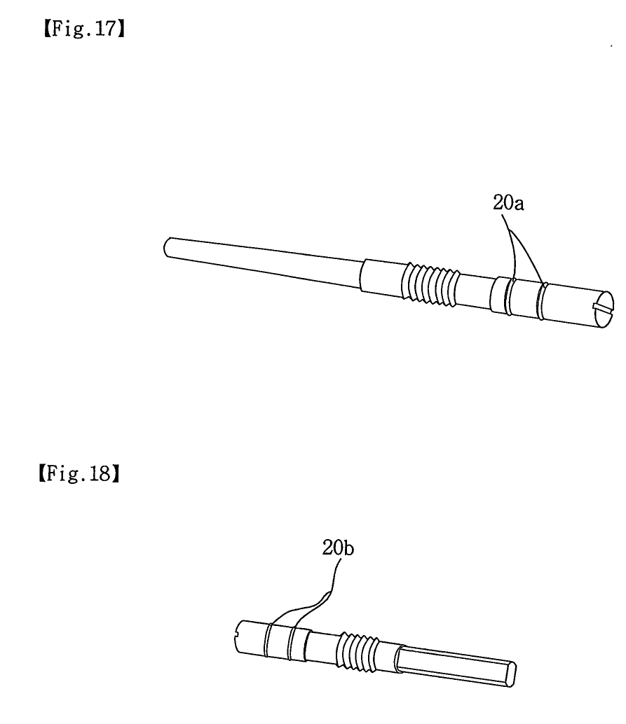

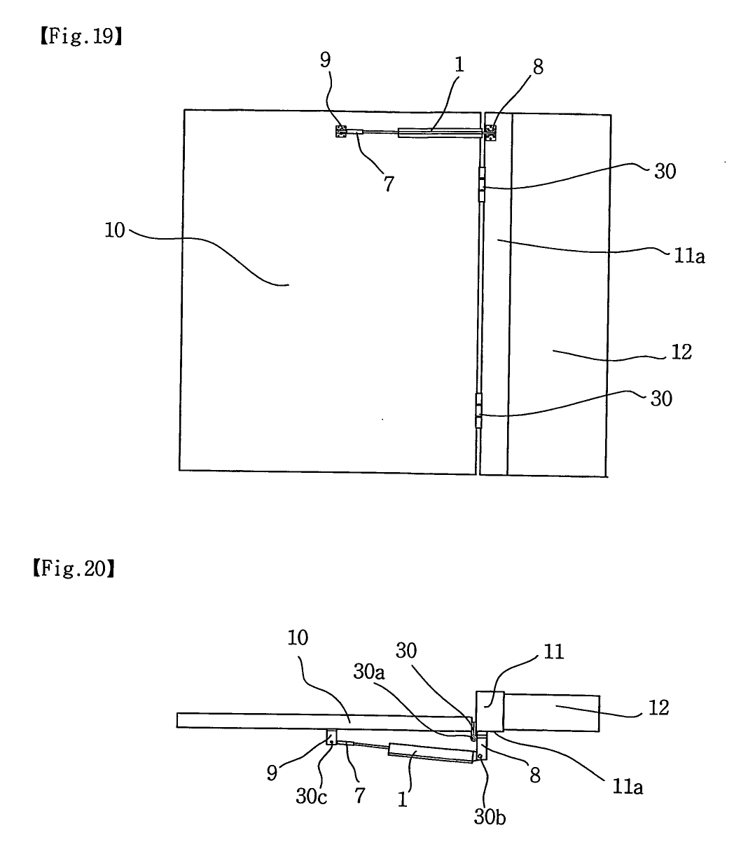

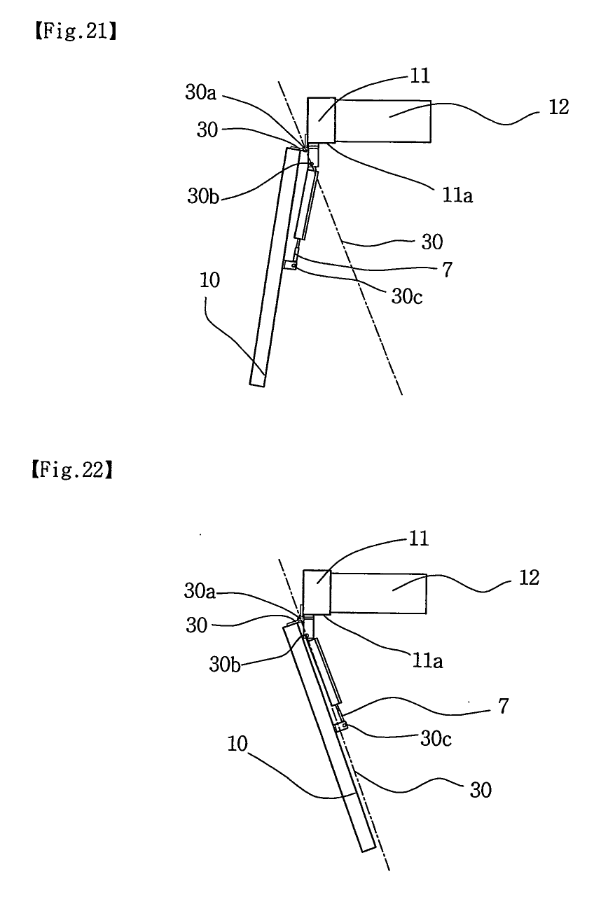

In the present apparatus comprising the above elements, the piston 2 and the piston rod 3 in FIG. 5 are pushed to the right side to compress the spring 5 as the door in FIG. 20 is opened. At this time, the ball 2b in the hole 2a in FIG. 7 is pushed to the left side, thereby leading hydraulic oil in the cylinder chamber la to flow quickly out to the cylinder chamber lb. The ball 2b is blocked by the catch rod 2a′ so that it can not escape outside and the hydraulic oil flows quickly out around the ball, thereby allowing the door to open quickly. On this occasion, when the hydraulic oil flowing out of the cylinder chamber la flows in the cylinder chamber 1b, a little air contained in the cylinder is compressed to adjust the inflow flux as much as the volume of the moving piston rod 3. A spring guide 4 is assembled between the piston 2 and the spring 5 for the spring to be evenly compressed and expanded, thereby preventing damage of the inner wall of cylinder while the spring 5 compresses and expands. In FIG. 22, if the door 10 is open at more than a certain angle it remains opened by the spring 5 without holding the door. That is, when the door is open at more than a certain angle, as in the FIG. 22, the rotation center 30c is at the side of the wall 12 in reference to the connection line of centerline 30, which is a connection line of a centerline 30a and a centerline 30b. Then, a pushing force of the spring 5 makes the door opened more and keeps the door opened. When the door is open at less than a certain angle, as in the FIG. 21, the rotation center 30c is at an opposite side of wall 12 in reference to the connection line of rotation center 30, then the force of spring 4 makes the door closed. That is, if the door 10 is closed a little when it is opened or if the door 10 is released when it is opened at less than a certain angle, a restoration force of the spring 4 pushes the piston 2 and the piston rod 3 to the left hand side to close the door 10. On this case, in order for the door to be closed, the ball 2b in the hole 2a in FIGS. 7 and 8 is pushed to the right hand side by flow of the hydraulic oil and the hole is closed, thereby leading the hydraulic oil to slowly flow in the cylinder chamber 1a from the cylinder chamber 1b passing through oil hole 1e, 1f, 1c, and 1d. At this time, a little amount of air contained in the cylinder expands as much as the volume of the moving piston rod, and also the oil hole 1d is increased or decreased by turning the speed adjustment bolt 6a, thereby adjusting a flux of the hydraulic oil and closing speed of the door. The oil hole 1e is increased or decreased by turning the fine speed adjustment bolt 6b, thereby adjusting the last closing speed of the door. That is, when the door opens and begins to get closed, the closing speed of the door is adjusted according to the size of oil hole 1d by the speed adjustment bolt 6a until the piston 2 reaches to the position of the oil hole 1f, but after passing the oil hole If the last closing speed of the door is adjusted according to the size of oil hole 1e by the fine speed adjustment bolt 6b. In FIGS. 5 and 11, if the force adjustment nut 7 is turned to the left or right hand side, the female screw formed inside the force adjustment nut 7 pushes the male screw 3a formed on the one side end of the piston rod to outside or pull it to inside, thereby making the closing force of the door to be strong or weak. In terms of an installation, when the male screw 3a is completely pulled to the doorframe mounting device 9, the present invention fixed to the door 10 and front face of the doorframe 11a, and the male screw 3a is pushed to the cylinder side by turning the force adjustment nut 7, thereby enabling the closing force of the door to be strong and the installation to be easy. On the other hand, in FIG. 20, the additional supporter 8a may or may not be installed underneath the doorframe mounting device 8 according to the degree of protrusion in height of the front face of doorframe, to which the doorframe mounting device 8 is attached in reference to the rotation center 30a of the hinge 30. That is, when it is protruded high, the rotation center 30b becomes high so that the additional supporter 8a is not installed, and when it is protruded low, the rotation center 30b becomes low, and the additional supporter 8a is installed to raise the rotation center 30b. Therefore, if it is installed, the rotation center 30b is raised and the force is improved, but the moving distance of the piston rod is prolonged when the door opens and closes, so that the entire length of the present invention is prolonged and unreasonable force is applied to the wall, and therefore a use of proper selection is required.

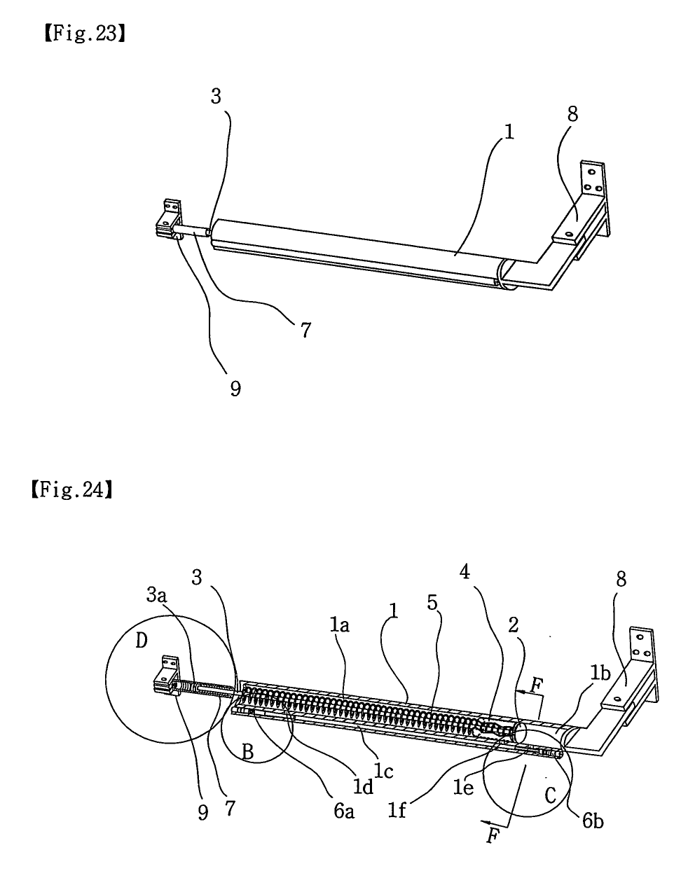

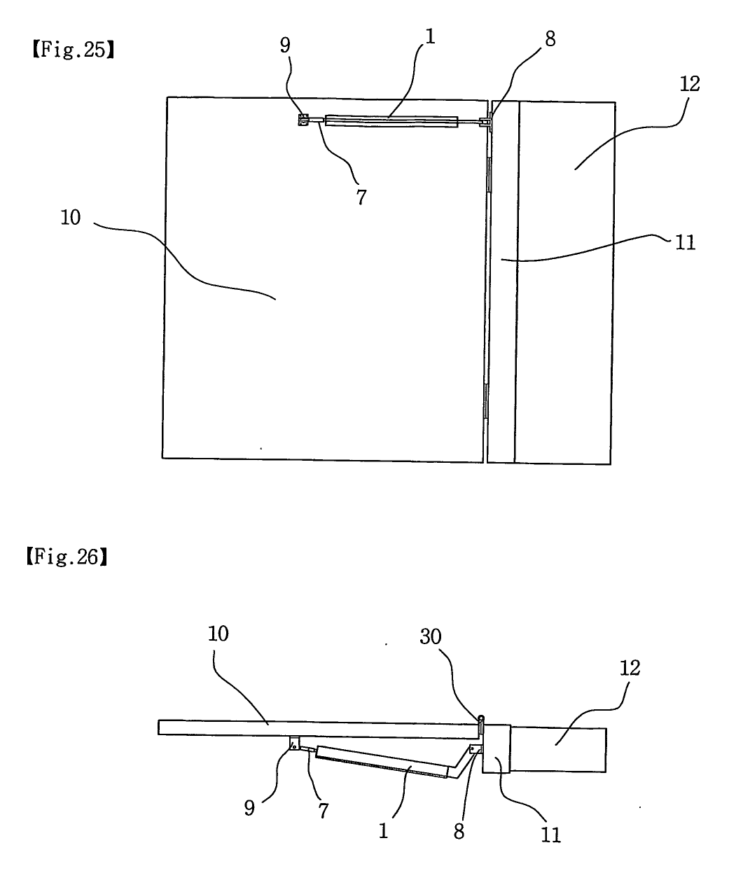

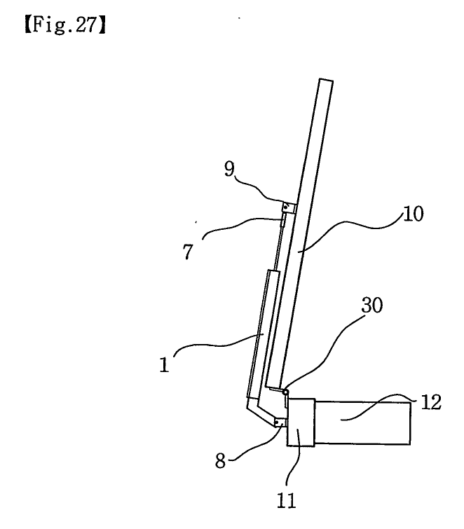

As describe above, the present invention is installed to the opening side of the door, so that the door is closed by the force pushing toward the door. In case where it is installed to the closing side of the door, FIGS. 23 and 24 of the same principle can be used. In this case, in FIG. 5, the internal structural view of the invention which is installed to the opening side of the door, mounting position of the spring 5, the spring guide 4, the speed adjustment bolt 6a, and the oil hole 1d is changed to the left from the right hand side in reference to the piston 2, and mounting position of the fine speed adjustment bolt 6b and the oil hole 1e, 1f is changed to the right from the left hand side, and also the piston is attached to the piston rod 3 in 180 degree rotated. In terms of the installation, the door closer of the invention is fixed to the door 10 and the doorframe 11 after disposing the male screw 3a to the end of right hand side of the force adjustment nut 7, and then the male screw 3a is pulled to the door mounting device 9 by turning the force adjustment nut 7, so that the closing force of the door becomes strong. In addition, in the perspective view of the invention (FIG. 23) and the internal structural view (FIG. 24) in case of an installation to the door closing side, the door is closed by the force pulling toward the door.

### INDUSTRIAL APPLICABILITY

The present invention can be used to most of the opening and closing doors for automatic closing of the door. The cylinder 1 in the present invention can be manufactured by aluminum casting, but it can be produced inexpensively in terms of production cost by aluminum extrusion, and the piston rod 3 is finished with a thin dense chromium plate to prevent from getting rust as well as to improve the surface roughness of the piston rod, thereby preventing a leakage of the hydraulic oil when the piston rod slides forward and backward. In addition, the additional supporter 8a may or may not be installed underneath the doorframe mounting device 8 according to the degree of protrusion of the front face of doorframe 11a in reference to the rotation center. That is, if installed, the force is improved but the moving distance of the piston rod is prolonged during opening and closing the door, and thus entire length of the present invention is prolonged and unreasonable force is applied to the wall, so that it requires a proper selection and use. However, if the front face of the doorframe 11a is protruded too high in reference to the rotation center of the hinge, a doorframe mounting device in low height needs to be used. Also, a spring guide 4 made of a type of plastic material is installed inside the cylinder 1 in order to prevent the inner wall surface of the cylinder from damage by the spring 5 when the spring expands and compresses and to help the spring to evenly expands and compresses. If the amount of air contained in the hydraulic oil is more than a proper amount, a noise generates when the piston 2 and the piston rod 3 moves to the right and left hand sides and moving speed of the piston rod to the right and left sides is irregular, and if the air is contained less than the proper amount, the piston and the piston rod don't move to the right and left hand side, and therefore, a little proper amount of air needs to be contained to just move the piston and the piston rod to the right and left hand side. For installation, the door mounting device 9 is fixed to the door 10 and the doorframe mounting device 8 is fixed to the front face of doorframe 11a using a nail or a screw. Then, the opening and closing force is set properly by turning the force adjustment nut 7, and closing speed is adjusted by turning the speed adjustment bolt, and the installation is finished and the present invention can be used. In addition, the present invention can be applied to the opening and closing doors from a big to a small door. In particular, the present invention has a nice appearance so that it is suitable to the place where the beauty is regarded as an important factor, also the present invention is suitable for the door, which is weak and the mounting area is easily damaged. Also, even a beginner can easily install the present invention to the door because it does not require a skill for installation.

What is claimed is:

1. A door closer which is fabricated in a hydraulic or air cylinder shape in its body, wherein a subsidiary plate 9a with a subsidiary pin 9b is assembled to a door mounting device 9 installed at a door 10, and a force adjustment nut 7, which is rotatable to right or left side, is assembled to the subsidiary plate 9a so that it can change the position of a piston rod 3 to the door 10 or to a doorframe 11;
wherein a cylinder 1 is assembled to a doorframe mounting device 8 installed at the doorframe 11, a surface of the cylinder 1 being provided with hemi-cylindrical shaped protrusions, in which an oil-hole is formed and a speed adjustment bolt is assembled at end thereof, extending linearly in the longitudinal direction, a piston 2, and a spring 5 is mounted in the cylinder I and hydraulic oil containing a little amounts of air is filled in the cylinder 1, the piston rod 3 is extending from an inner side to an outer side of the cylinder 1, one end of the piston rod 3 being provided with the piston 2 and the other end thereof being provided with male screw 3a in which minor diameter of an external thread is greater than a diameter of the piston rod 3: and
wherein the door mounting device 9 including the force adjustment nut 7, subsidiary plate 9a and subsidiary pin 9b, and the doorframe mounting device 8 including the cylinder 1, the piston rod 3 and the male screw 3a, can be assembled and separated from each other by the force adjustment nut 7 provided at the door mounting device 9, and the male screw 3a provided at the one end of the piston rod 3.

2. The door closer of claim 1, wherein an additional supporter 8a of a rectangular shape can be, if needed, provided at lower surface of the doorframe mounting device 8, a longitudinal and transverse length thereof being identical with those of the lower surface of the doorframe mounting device 8, and holes corresponding to screw holes formed at lower surface of the doorframe mounting device 8 is formed at the additional supporter 8a so as to fix the doorframe mounting device 8 to the doorframe 11, with forming an additional central hole in the supporter 8a for assembling with the doorframe mounting device 8.

3. The door closer of claim 2, wherein the additional supporter 8a is made of materials selected from plastic group.

4. The door closer of claim 1, wherein the piston 2 is provided with a hole 2a and is connected to one end of the piston rod 3, an catch rod 2a′ being formed at the hole 2a and a ball 2b is received therein, and the male screw 3a is formed or attached to other end of the piston rod 3 so that the piston rod 3 can be moved in the force adjustment nut 7 , the minor diameter of an external thread being greater than the diameter of the piston rod 3.

5. The door closer of claim 1, wherein the force adjustment nut 7 is exposed to outside to make it easy to mount and control force, an female screw being formed at inside of the force adjustment nut 7 so that the piston rod 3 can be moved in the force adjustment nut 7, the minor diameter of the internal thread being greater than the diameter of the piston rod 3, and in addition, the force adjustment nut 7 has a cylindrical shape with a big central through-hole extending therethrough, one end of it being blocked by a round plate with a small central through-hole.
